(19) United States
(12) Patent Application Publication
(10) Pub. No.: US 2024/0209974 A1
(43) Pub. Date: Jun. 27, 2024

(54) PIPE CAP

(71) Applicant: ZOOK Group, Killamarsh (GB)

(72) Inventors: Gregory D. Clark, Aurora, OH (US); Richard N. Clark, Beauchief (GB)

(21) Appl. No.: 18/393,970

(22) Filed: Dec. 22, 2023

Related U.S. Application Data
(60) Provisional application No. 63/435,373, filed on Dec. 27, 2022.

(51) Int. Cl. F16L 55/115; F16L 57/00

(52) U.S. Cl. CPC F16L 55/1157; F16L 57/00

(57) ABSTRACT

A pipe cap includes a base, a cover, and an anchor assembly connecting the cover to the base. The base is connected to an open end of a vent pipe, and includes a sealing surface. The cover seals to the sealing surface and thereby seals the open end of the pipe so as to allow a build-up of pressure within the pipe. When the pressure exceeds a predetermined threshold value, the cover is blown off of the base to expose the sealing surface. The cover has a different visual appearance than the sealing surface. Thus, exposure of the sealing surface provides a visual indication of the occurrence of the pressure event.

The present application claims priority to U.S. Prov. Patent App. Ser. No. 63/435,373, filed Dec. 27, 2022, the entirety of which is incorporated herein.

### BACKGROUND

Pipelines are used for transporting various fluid materials from one location to another. These fluid materials may experience an increase in pressure while inside the pipelines, which increase in pressure may be caused by an increase in temperature or volume of the fluid, a blockage in the pipeline, etc. To account for this increase in pressure and to prevent such increase in pressure from damaging the pipeline, a pressure relief device such as a pressure release valve or rupture disk assembly and a downstream vent pipe may be incorporated into the pipeline in order to allow the pressurized fluid to escape from the pipeline, through the pressure release valve or rupture disk assembly, and out of the vent pipe without causing damage to the pipeline.

The vent pipe is open at one end opposite from the pressure relief valve or rupture disk assembly in order to allow for the release of the pressurized fluid. However, environmental contaminants, such as rain, dirt, bird fouling, snow, insects, small animals, or other foreign materials, may enter through the open end and enter the vent pipe, and may contact the pressure relief valve or rupture disk assembly, which may cause deterioration of the pressure relief valve or rupture disk assembly.

Various devices for covering the open end of the vent pipe exist in order to protect the pressure relief valve or rupture disk assembly, which may be expensive to replace or fix. One such device is a flexible polyvinylchloride (PVC) cover that is fit over the open end of the vent pipe to seal the open end. The cover contacts, and thus creates a seal with, the outside surface of the pipe. This seal allows for a certain amount of pressure to build up inside the pipe, which pressure eventually blows the cover off of the open end of the vent pipe. This build-up of pressure and blowing off of the cover is referred to herein as a “pressure event” or “increased pressure situation,” and these may occur at a relatively low pressure in the vent pipe, typically 0.5 psig.

The cover is connected to a retaining strap or collar, which is installed first to the pipe by being slipped around the outside of the vent pipe and is forced down on the pipe's outside diameter. Thereafter the cover is arranged over the open end of the pipe. When the cover is blown off of (i.e. released from) the vent pipe during a pressure event in order to release the buildup of pressure, the retaining strap remains anchored around the outside diameter of the pipe, and thus prevents the cover from being blown away from the vent pipe and possibly becoming lost. The blown off cover may be hanging from the strap or just slightly removed (i.e. not totally blown off) from the end of the pipe, which is referred to herein as a “failure condition,” and thus may provide a visual indication that a pressure event has occurred. Once the increased pressure situation is resolved, the cover can be reused by being reapplied over the open end of the vent pipe to again protect the pressure relief valve from exposure to environmental contaminants.

This type of known device has a number of deficiencies. One is that in order to assure proper functioning of the device, a user must properly install the cover and strap onto the end of the pipe. For example, a user must ensure that the condition of the outside surface of the pipe is clean and smooth in order for the cover to adequately seal to the outside surface, thus allowing for a buildup of pressure. This may be difficult, since the condition of the outside pipe may deteriorate over time, such as from the first installation date through and until the current use. This deterioration may occur due to foreign material build-up, corrosion, weathering effects of the environment etc. The successful release of the cover from the vent pipe is dependent on the seal between the cover and the pipe itself. If the condition of the outside surface of the pipe has deteriorated since the initial installation of the device, the seal between the cover and the pipe may become stronger than the original installation, and then there is a chance that the cover may not be released at the expected pressure at which it is designed to operate. Moreover, once the cover is released during a pressure event, the deteriorated outside surface of the pipe may inhibit the cover from resealing with the outside surface. Therefore, this type of device requires the outside surface to remain pristine at all time during use of the cover.

Additionally, painted surfaces or other coatings on the outside of the pipe must be fully cured, so that they do not stick to the cover and prevent it from being blown off the vent pipe. Furthermore, the strap and cover have to be correctly positioned with respect to each other on the end of the pipe, so that the strap is anchored to the pipe at an anchor location that is relatively close to the cover. This proper relative positioning provides some slack in the strap, which allows the cover to move away from the anchor location when the cover is blown off of the pipe. Another deficiency is that the device may not be easily seen, such as through dense, wooded areas or through man made visual interferences. Further, a user may find it difficult to see the failure condition of the device and thus may not be able to easily distinguish between the failure condition and a normal installation. The functioning of the device may also be hampered by human interactions, such as application of the same color paint to the device and to the vent pipe, making it very difficult to differentiate if the device is installed or not.

A second type of known device is similar, but includes a whistle, which is operated by the increase in internal pressure in the vent pipe. The sound produced by the whistle indicates that there is pressure leakage through the pipeline. When the pressure increases sufficiently, the flexible cover is blown off of the end of the pipe. To stop the cover from flying far away, a lanyard is secured to the pipe and to the cover. Like the first type of device, this device requires proper installation and use. Further, the effectiveness of the lanyard is only as good as the securing knots that are used to connect it to the cover and pipe. Additionally, if the lanyard deteriorates due to exposure to the environment, then the lanyard may fail and not anchor the cover during a pressure event.

A third type of known device includes a rigid cover including internal thread, which is screwed onto a threaded end of a vent pipe, thus ensuring a permanent connection. The cover has an integral flap that covers the opening in the vent pipe, but during a pressure event opens outwards to release the buildup of pressure in the vent pipe. Once the pressure is released, the flap closes again to cover the opening. This device is deficient because most vent pipe ends are not threaded, and few users will go to the trouble of applying a threaded end to the vent pipe for installing the threaded cover. Moreover, the thread on the pipe may become rusty and unserviceable over time, thus requiring further modifications. The flap may also stick due to atmospheric debris depositing into the moving parts of the device.

### SUMMARY

A cap for covering an open end of a pipe includes a base including a sealing surface, the base being configured to connect to the open end of the pipe; a cover configured to seal the open end of the pipe and to seal to the sealing surface so as to allow a build-up of pressure within the pipe, and to be blown off the sealing surface when the pressure exceeds a predetermined threshold value, the cover having a different visual appearance than the sealing surface; and an anchor assembly connecting the cover to the base before, during, and after the pressure event, and allowing the cover to be blown off of the sealing surface during the pressure event.

A method of monitoring for the occurrence of a pressure event inside a pipe, including arranging a base, including a sealing surface, to an open end of the pipe; sealing a cover to the sealing surface, the cover sealing the open end of the pipe so as to allow a build-up of pressure within the pipe, the cover being configured to be blown off the sealing surface when the pressure exceeds a predetermined threshold value, the cover having a different visual appearance than the sealing surface; and connecting the cover to the base with an anchor assembly, the anchor assembly being configured to connect the cover to the base before, during, and after the pressure event, and allowing the cover to be blown off of the sealing surface during the pressure event.

### BRIEF DESCRIPTION OF THE DRAWINGS

FIGS. 1A and 1B are perspective views of a pipe cap according to the present subject matter.

FIGS. 2A and 2B are perspective views of another pipe cap according to the present subject matter.

FIGS. 3A and 3B are perspective views of another pipe cap according to the present subject matter.

FIGS. 4A and 4B are perspective views of another pipe cap according to the present subject matter.

FIGS. 5A and 5B are perspective views of another pipe cap according to the present subject matter.

FIG. 6 is a perspective view of a cover for the pipe cap according to another aspect of the present subject matter.

FIGS. 7A, 7B and 7C are elevation views of the cover of FIG. 6.

### DETAILED DESCRIPTION

The present subject matter provides a cap for covering an open end of a pipe, for example a vent pipe on a fluid transport pipeline. The cap seals the open end of the vent pipe, and a failure condition of the cap provides a visual indication that a pressure event occurred within the vent pipe. The cap may provide a seal over the open end of the vent pipe, independent of the condition of the outside surface of the pipe. Thus, when compared to conventional pipe covers—which experience a failure condition dependent on the condition of the outside surface of the pipe, e.g. level of smoothness, rust, cleanliness, the presence of coatings that could become sticky, in essence required the outside surface to be in pristine condition at all times—the cap more consistently experiences a failure condition when an internal pressure in the pipe exceeds a predetermined threshold value. The cap may be made from materials such as a fluoropolymers so as to provide a corrosion resistant, ultra-violet resistant, self-supporting, shrink-free, lead-free, flame retardant, non-toxic, durable and re-useable product.

Referring now to the drawings, wherein like numerals refer to like parts throughout the several views, the pipe cap 2 includes a base 4 that connect to a pipe 6, a flexible cover 8 that seals to the base and thereby seals an open end 10 of the pipe, and an anchor assembly 12 connecting the cover to the base and allowing movement of the cover with respect to the base. These components may be made from plastic injection and extrusion, as opposed to a dipping process, to ensure greater accuracy for the geometry of the components resulting in better repeatability, quality control, performance and safety. The base 4 may be manufactured to fit over various pipe outside diameters so as to allow for installation on all standard and nonstandard piping systems.

The pipe 6 may be a vent pipe connected downstream from a pressure relief valve or rupture disk assembly of a pipeline for transporting a fluid, or another type of pipe as desired. The pipe may be arranged such that a longitudinal axis is vertical or substantially so, e.g. within 20 degrees of vertical and the opening is facing up. However, this is not required, and the pipe may be arranged at other angles such that the opening is facing sideways or downward.

The base 4 is connected to the pipe 6 at the opening or open end 10. The base may be connected to the inside surface of the pipe, the outside surface of the pipe, or both the inside and outside surfaces of the pipe. The connection between the base and the pipe is not particularly limited, and may be a permanent or removable connection, for example, a mechanical connection (e.g. a threaded connection, a friction connection), an adhesive connection, a welded connection, or combinations thereof.

The base 4 provides a sealing surface 18 that is contacted by the cover, and with which the cover can form a seal over the opening to close off the open end of the pipe and thus allow for a pressure build-up inside the pipe. When a pressure event occurs inside the pipe that exceeds a predetermined threshold pressure value, the pressure inside the pipe breaks the seal by causing the cover to come off of the sealing surface and the base, thus providing an escape route for the build-up of pressure from the vent pipe. The blown off cover and the exposed sealing surface of the base both give an indication of the occurrence of the pressure event.

The cover does not seal directly to the outside surface of the pipe 6, as do conventional covers. Consequently, the end of the pipe (i.e. inside or outside surfaces of the pipe) does not have to be/remain clean and smooth in order for the cover to adequately seal to the outside surface, or to slide off of the outside surface during a pressure event. Instead, the open end 10 of the pipe 6 only needs to be suitable for connection to the base, which can be a one-time event that, depending on the connection type, may not require the outside surface of the pipe to be a clean and smooth. Since the sealing surface is on the base instead of on the pipe, the sealing surface may be first exposed to the environment at the same time the cover is first exposed to the environment, and thus the sealing surface may be clean and smooth and not deteriorated due to prior exposure to the environment. If instead, the sealing surface were on the vent pipe as is conventional, then the sealing surface would have been exposed to the environment from the moment of its installation on the pipeline, and before the cover is installed over the end of the vent pipe, and thus may be deteriorated (e.g. rusty, dirty, etc.) from such prior exposure to the environment, and thus may require a significant amount of modification (e.g. cleaning, scraping, grinding, etc.) to make it suitable for sealing with the cover, and for properly releasing the cover during a pressure event.

Because the sealing surface 18 is on the base 4, and thus is not exposed the environment prior to application of the cover on the vent pipe 6, this limits the amount of exposure of the sealing surface to the environment and limits the amount of degradation to the sealing surface as a result of such exposure. Limiting the exposure to the environment, and thus limiting the associated degradation of the sealing surface, provides a clear advantage for forming the seal between the sealing surface and the cover, and for releasing the cover from the sealing surface during a pressure event. In other words, the cover not only covers over the open end 10 of the pipe 6, but also covers the sealing surface of the base 4, thus inhibiting degradation of the sealing surface from exposure to the environment and preventing the sealing surface from being painted over, and thus retaining an Andon indication provided by exposure of the sealing surface during a pressure event.

To further inhibit deterioration of the sealing surface 18 and allow for proper sealing and release of the cover during a pressure event, the sealing surface may be made of material that is more durable to exposure to the environment than the material of the pipe. In this regard, the sealing surface of the base may comprise a material that does not rust, e.g. a polymer. As such, it may provide a clean and smooth surface for sealing with and releasing the cover.

The base 4 may have a general shape of a tube, and an outside surface that includes the sealing surface. The base may be connected to and around the outside surface of the pipe 6 as shown in the figures, to the inside surface of the pipe, or to the end of the pipe by butting up against and being connected to the end surface of the pipe at a butt joint. The connection between the base and the pipe may be air tight, or substantially so.

The sealing surface 18 may act as an Andon indicator, which is a system that provides a visual indication of the status of operations of the cap at a single glance, and signals whenever an abnormality occurs, when the cover is in a failure condition (i.e. blown off of the sealing surface and hanging down from the anchor assembly).

In particular, the sealing surface 18, and optionally the entire base 4, may have a visual appearance that differs from the visual appearance of the cover. The different visual appearances of the sealing surface and cover may be a result of a difference in their colors, textures, reflections, refractions, luminescence (e.g. fluorescence, photoluminescence), absorption, or other visually perceptible characteristics or combinations thereof. In a non-limiting embodiment, the sealing surface may have a color that differs from the color of the cover. The color of the sealing surface may be red (that being the universal color associated with manufacturing failure or danger), and the color of the cover may be yellow or other colors that may signify different applications in a plant, or different levels of potentially toxic releases during a pressure event. However, this is not required and these components may have other colors. Because of their different visual appearances, when the cover is blown off of the sealing surface during a pressure event, the sealing surface is exposed, and the color of the sealing surface may provide a visual contrast with the color of the cover, which is normally arranged on the end of the pipe to seal the opening. However, when the cover is in the failure condition and off of the end of the pipe, the color visible at the end of the pipe is defined, not by the color of the cover, which has been blown off and is hanging from the anchor assembly, but by the color of the base, thus providing a quick and easy way for user to determine if a pressure event has occurred.

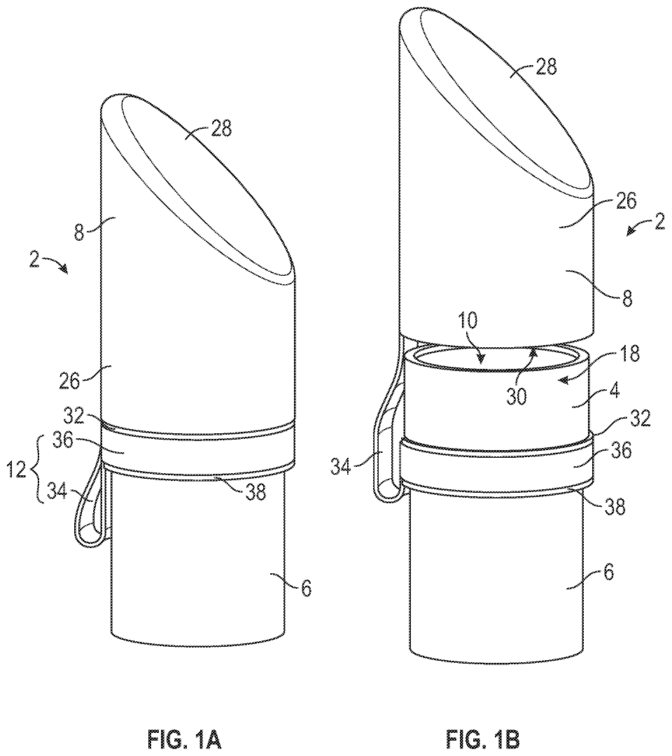

In FIGS. 1A and 1B, the cover 8 is elastic, and may have a general shape of an upside down cup including a tubular sidewall 26 extending downward from a closed end 28 and defining an open bottom 30. The cover is arranged over the base 4, such that the sidewall of the cover is arranged around and in contact with the sealing surface 18 of the base to form a seal therewith. The sidewall may have an inside diameter size that is a function of the outside diameter size of the sealing surface so as to securely fit over the base 4 and create the seal.

When the cover 8 is arranged over the base 4, the sidewall 26 and closed end 28 of the cover, along with the base, collectively operate to close off the open end 10 of the pipe 6 so as to allow the build-up of pressure. Additionally, the closed end 28 may be sloped, so as to shed water, ice, or other environmental contaminates and to inhibit drooping of the closed end.

The elastic sidewall 26 of the cover 8 may be stretched over and around the sealing surface 18 of the base 4, and may be pulled down over the sealing surface so as to create the seal. The seal may be maintained by friction between the cover 8 and the sealing surface 18, which friction is created by the elastic sidewall 26 contracting radially inward toward the sealing surface 18. The seal may be maintained by the friction even when exposed an internal pressure in the pipe that is below the predetermined threshold value. In this case, the cover 8 allows for a certain amount of build-up of pressure inside the pipe. However, when the cover is exposed to an internal pressure in the pipe 6 that exceeds the predetermined threshold value (i.e. a pressure event), the friction does not maintain the seal, which instead is broken, and the cover experiences a failure condition by being blown off of the end of the pipe, thus indicating the occurrence of the pressure event.

When installed or reinstalled on the base 4, the cover 8 is pushed down over the sealing surface 18 until a sufficient seal is formed between them, which downward movement may be limited by a collar 32 on the base extending radially outward from the sealing surface. When the cover 8 is pushed down to contact the collar, this may indicate a recommended distance to push the cover down, and may provide a seal sufficiently strong enough to keep the cover on the base up to an internal pressure at the predetermined threshold value. When the cover is pushed down to contact the collar 32, the sealing surface 18 may be entirely covered by the cover, thus protected from exposure to the environment and inhibited from deteriorating due to such exposure.

The anchor assembly 12 may include various structures that collectively connect the cover 8 to the base 4 before, during, and after the pressure event, yet allow the cover to be blown off of the sealing surface during the pressure event. The anchor assembly may be integral with, or a separate element from, the base and/or from the cover. In any event, the anchor assembly keeps the cover secured to the base, even when the cover is blown off of the base during a pressure event. FIGS. 1-5 depicted non-limiting examples of the cover, anchor assembly, and base.

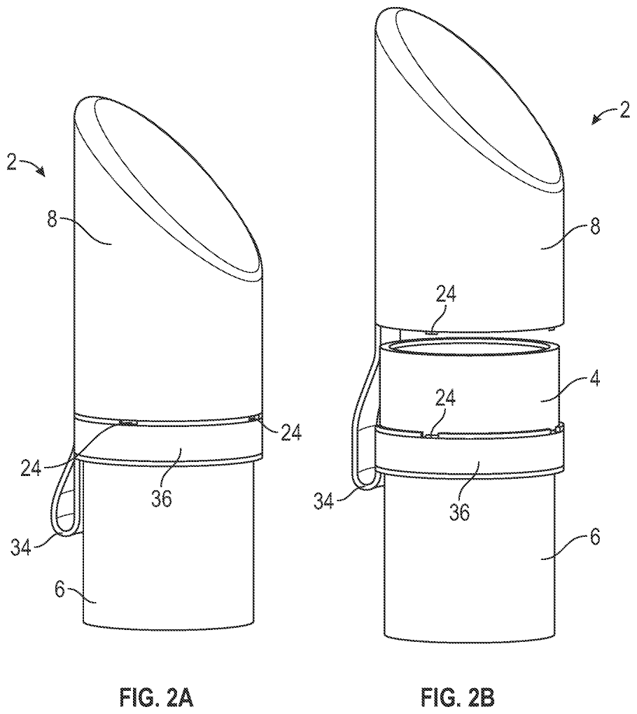

FIGS. 1A and 1B show the anchor assembly 12 including a strap 34 and a loop 36, which may be integral or not with each other, and integral or not with the cover 8. The loop may be permanently or removably attached around the base 4 below the collar 32, optionally in a groove defined between the collar and a bottom ledge 38 that extends radially out from the base 4 as shown in FIGS. 1A and 1B. As with the cover, the loop may be elastic and thus may contract radially inward around the base to anchor to the base. FIGS. 2A and 2B are similar to FIGS. 1A and 1B, but instead shows the loop being initially connected to the cover, not only by the strap, but also by breakable tabs 24 that are spaced around the circumference of the cover and loop and will break during a first pressure event so as to allow the cover to be blown off of the base. Broken tabs may provide an indication of an initial pressure event. The tabs might also provide a more accurate amount of resistance to prevent the cover from blowing off of the base when there is a build-up of pressure inside the pipe. This may allow the cover to be blown off at an internal pressure more-consistently close to the predetermined threshold value. After being broken during the pressure event, the tabs may be configured to be reattached to the cover, loop, or both.

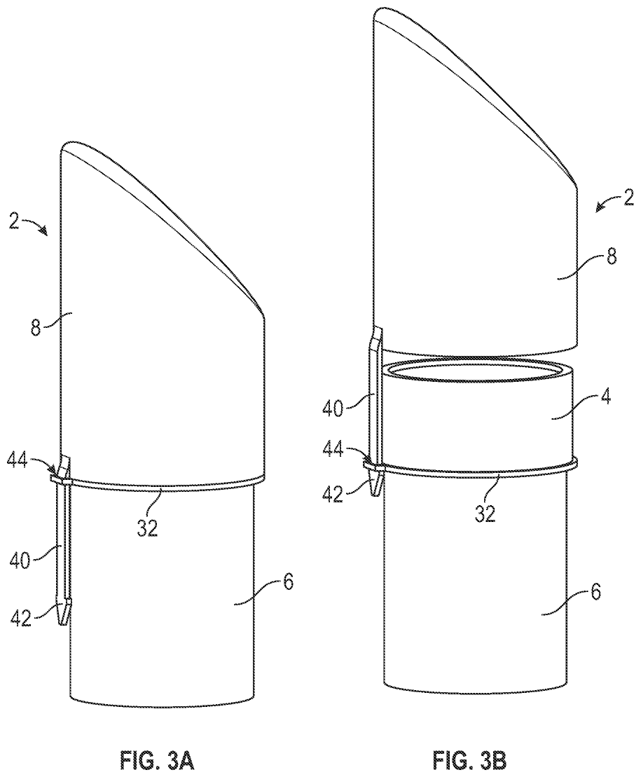

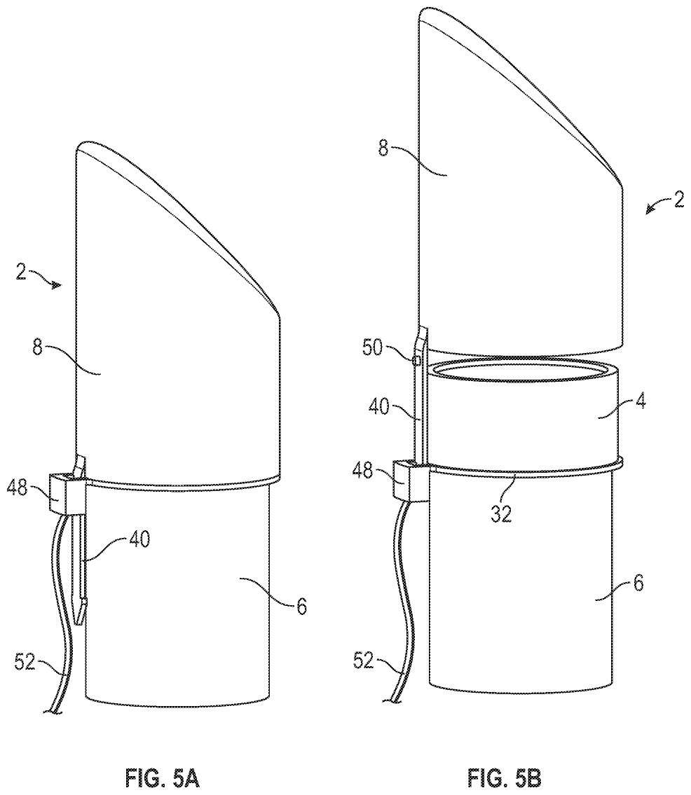

When the cap is installed (FIGS. 1A and 2A), the strap 34 has slack in it so as to allow movement of the cover 8 with respect to the base 4 and with respect to the loop 36 during a pressure event, such that the cover can be blown off of the base without the strap interfering with the movement of the cover off of the base (FIGS. 1B and 2B). As can be seen, the strap 34 is connected at the bottom edge of the cover 8 and the bottom edge of the loop 36. However, this is not required, and the strap can be connected at different locations on the cover and loop. While FIGS. 1B, 2B show the cover 8 in the failure condition arranged above the open end 18 of the pipe 6, this is done for convenience to show the slack in the strap allowing for the cover to be fully blown off the base. It should be realized however, that this may not accurately show a failure condition of the cover, where instead the cover may be hanging down from anchor assembly. A similar situation is shown in FIGS. 3B and 5B.

FIGS. 3A and 3B show the anchor assembly including a lanyard 40 connected to and extending down from the cover. The lanyard 40 includes an enlarged tip 42 (e.g. in the shape of an arrow head). The lanyard, including the tip, is inserted from above through a hole 44 in the collar (FIG. 3A), which hole is sized smaller than the tip. During a pressure event (FIG. 3B), the lanyard is pulled upward by the blown off cover, and thus slides upward within the hole until the enlarged tip reaches the hole. The enlarged tip is prevented from passing through hole because of their relative sizes, and thus prevents the lanyard from completely escaping the hole. By this, the cover is retained to the base. The lanyard may be integral with the cover.

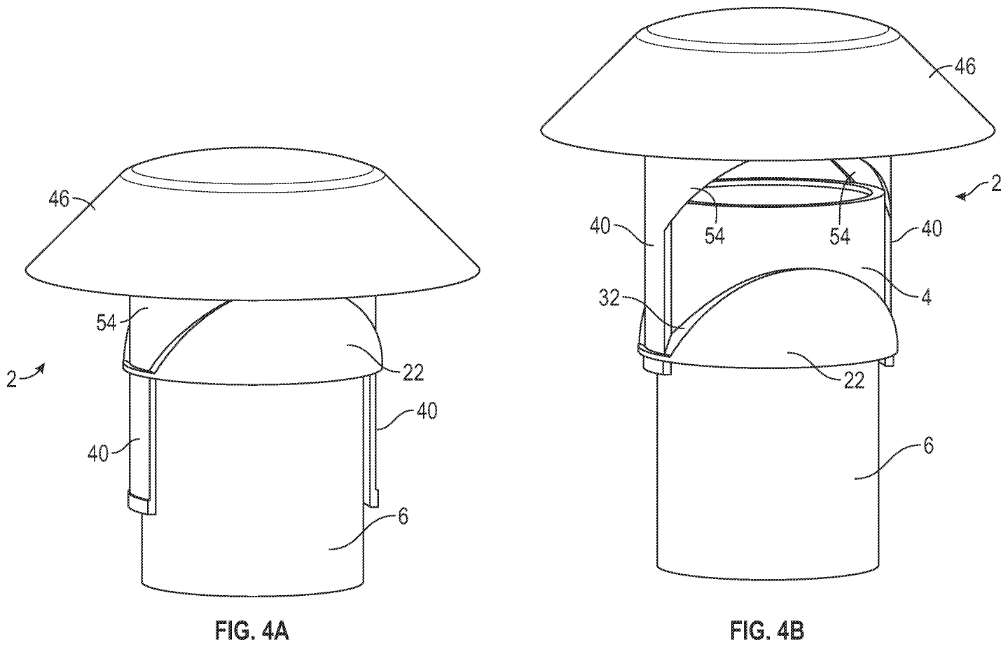

FIGS. 4A and 4B are similar to FIGS. 3A and 3B, but instead includes two lanyards 40 having enlarged tips extending down from the cover, and inserted through two holes in the collar. The collar of the base is somewhat different than in the other figures, and includes two upwardly rounded convex portions 22, each extending between the two holes, and which mate with two corresponding downwardly rounded concave portions 54 on the cover when the cover is fully installed on the base (FIG. 4A). Furthermore, the cover includes an umbrella shaped hood 46 extending radially out past the sidewall. During a pressure event, the cover is blown off of the base, yet because of guidance provided by the two lanyards, remains above the opening in the pipe (FIG. 4B). For this purpose, the two lanyards may be somewhat rigid in order to maintain the arrangement of the cover in this arrangement above the opening in the pipe. This arrangement of the cover and hood shown in FIG. 4B provides space for the escape of pressurized fluid from the pipe, yet protects the interior of the pipe from weather and animals and animal nests because the hood is arranged above the opening in the pipe. This feature is different than the other embodiments disclosed herein, where the cover may be blown off of the pipe and hang in the failure condition from the side of the pipe. Here however, the cover remains over the pipe in the failure condition as shown in FIG. 4B. To keep the cover over the pipe in the failure condition rather than having it slide back down onto the pipe after the pressure event, the holes on the collar and the enlarged heads on the lanyards may function to lock together wherein the heads are forced somewhat into the holes during the pressure event to thereby hold the cover over the pipe. Such locking may be reversible upon a user simply pushing down on the cover to break the locking by forcing the heads down out of the holes.

FIGS. 5A and 5B are similar to FIGS. 3A and 3B, but also includes a sensor 48 arranged on the cover or pipe, and optionally a button 50 on the lanyard. The sensor may be in communication with a computing system of a user, such as by wired connection 52 or wireless connection. The sensor can sense the presence of the button, or movement of the lanyard. During a pressure event, the button and the lanyard moves up away from the sensor due to the lanyard being pulled up by the cover being blown off the base. Movement of the button or lanyard away from the sensor during the pressure event is sensed by the sensor, and thus the sensor operates to sense the pressure event. The sensor may then communicate a signal, e.g. to the computing system, to provide an indication of the pressure event. The sensor and button are not particularly limited, and can include proximity sensor assemblies, position sensor assemblies, accelerometer assemblies, motion sensor assemblies, metal sensor assemblies, contact sensor assemblies, or others that can be used to detect the movement of the lanyard/button with respect to the sensor.

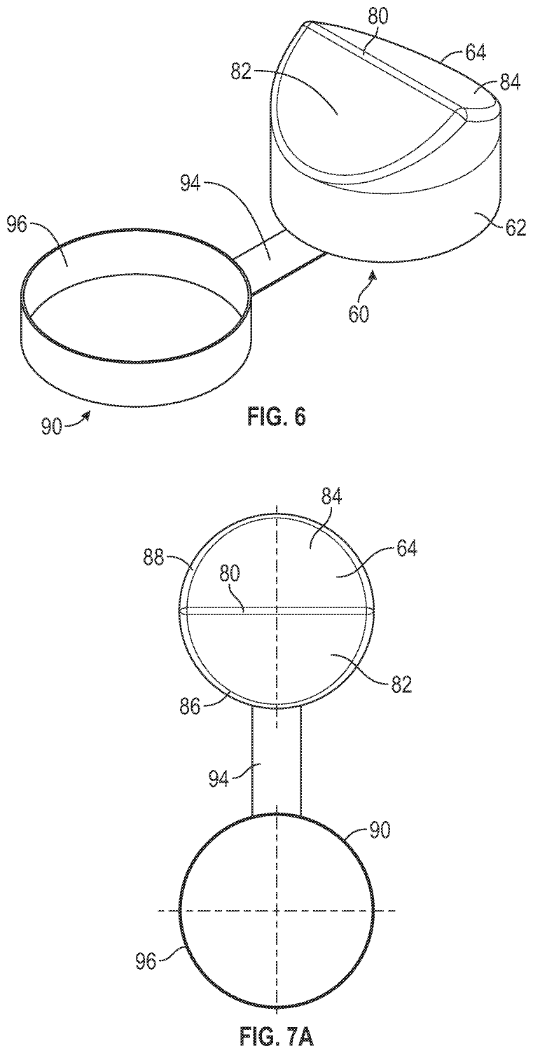

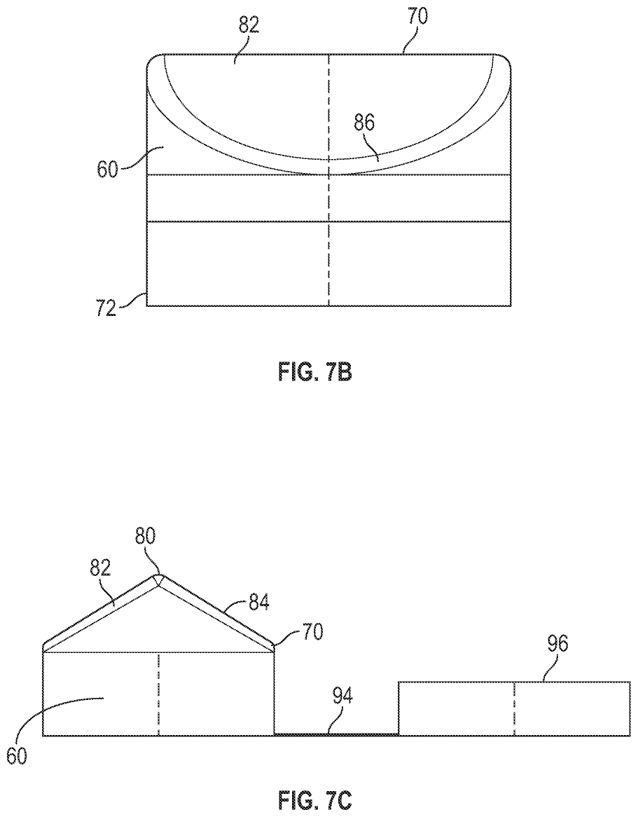

FIGS. 6-7C depict a cover 60 to be installed or reinstalled on the base 4 (see FIG. 1B) of the pipe cap 2 according to another aspect of the subject disclosure. The cover 60 is elastic, and includes a tubular sidewall 62 and a top wall 64. The sidewall 62 is shaped to correspond to a shape of the base 4, and has an upper closed end 70 defined by the top wall 64 and a lower open end 72. The top wall 64 includes a ridge portion 80 and sloping portions 82, 84. The sloping portions 82, 84 extend obliquely downward from the ridge portion (e.g., at 30 to 45 degree slope) to the upper end 70 of the sidewall 62. In the depicted embodiment, the sidewall is cylindrical shaped, and the ridge portion 80 is centrally located on the top wall 64 so as to extend diametrically relative to a central axis defined by the sidewall 62. Further, the sloping portions 82, 84 may be identically constructed, but for their disposition on opposite sides of the ridge portion 80. Each sloping portion 82, 84 includes a respective arcuate shaped edge portion 86, 88 such that in the top view of FIG. 7A each sloping portion 82, 84 is approximately semicircular shaped relative to the cylindrical shaped sidewall 62. Each sloping portion 82, 84 can be approximately planar such that in the side view of FIG. 7C the top wall 64 is approximately triangular shaped. Although, it should be appreciated that each of the sloping portions 82, 84 can be slightly concave or convex shaped depending the application of the pipe cap 2. Further, the sloped shape of each sloping portion allows for the shedding of water, ice, or other environmental contaminates and also inhibit drooping of the top wall 64.

Similar to the cover 8 described above, the cover 60 is arranged over the base 4, such that the sidewall 62 of the cover is arranged around and in contact with the sealing surface of the base to form a seal therewith. The sidewall 62 may have an inside diameter size that is a function of the outside diameter size of the sealing surface 18 of the base 4 so as to securely fit over the base 4 and create the seal. When the cover 60 is arranged over the base 4, the top wall 60 and the sidewall 62 of the cover operate to close off the open end 10 of the pipe 6 (see FIG. 1B) so as to allow the build-up of pressure.

The elastic sidewall 62 of the cover 60 may be stretched over and around the sealing surface 18 of the base 4, and may be pulled down over the sealing surface so as to create the seal. The seal may be maintained by friction between the cover 60 and the sealing surface 18, which friction is created by the elastic sidewall 62 contracting radially inward toward the sealing surface 18. The seal may be maintained by the friction even when exposed an internal pressure in the pipe that is below the predetermined threshold value. In this case, the cover 60 allows for a certain amount of build-up of pressure inside the pipe. However, when the cover is exposed to an internal pressure in the pipe 6 that exceeds the predetermined threshold value (i.e. a pressure event), the friction does not maintain the seal, which instead is broken, and the cover experiences a failure condition by being blown off of the end of the pipe, thus indicating the occurrence of the pressure event.

As discussed above with respect to the cover 8, when installed or reinstalled on the base 4, the cover 60 is pushed down over the sealing surface 18 until a sufficient seal is formed between them, which downward movement may be limited by the collar 32 on the base 4 extending radially outward from the sealing surface. When the cover 60 is pushed down to contact the collar, this may indicate a recommended distance to push the cover down, and may provide a seal sufficiently strong enough to keep the cover 60 on the base 4 up to an internal pressure at the predetermined threshold value. When the cover 60 is pushed down to contact the collar 32, the sealing surface 18 may be entirely covered by the cover 60, thus protected from exposure to the environment and inhibited from deteriorating due to such exposure.

An anchor assembly 90 connects the cover 60 to the base 4 and allows movement of the cover with respect to the base. Again, the anchor assembly 90 may include various structures that collectively connect the cover 60 to the base 4 before, during, and after the pressure event, yet allow the cover to be blown off of the sealing surface during the pressure event. The anchor assembly may be integral with, or a separate element from, the base and/or from the cover. In any event, the anchor assembly keeps the cover secured to the base, even when the cover is blown off of the base during a pressure event.

In FIGS. 6-7C, the anchor assembly 90 including a strap 94 and a loop 96, which may be integral or not with each other, and integral or not with the cover 60. The loop 96 may be permanently or removably attached around the base 4 below the collar 32, as described above. As with the cover 60, the loop 96 may be elastic and thus may contract radially inward around the base to anchor to the base. It should be appreciated that when the pipe cap is installed, the strap 94 has slack in it so as to allow movement of the cover 60 with respect to the base 4 and with respect to the loop 96 during a pressure event, such that the cover 60 can be blown off of the base 4 without the strap interfering with the movement of the cover off of the base. As can be seen, the strap 94 is connected at the lower open end 72 of the sidewall 62 of the cover 60 and a bottom edge of the loop 96; although, this is not required.

Accordingly, the cover 60 includes the top wall 64 configured with the central ridge portion 80 and the sloping portions 82, 84. The ridge portion 80 allows pressure to build up evenly and centrally to give a more consistent lift of the cover 60 from the vent pipe during an over pressure event. The ridge portion 60 also supports the weight of the pipe cap more evenly reducing the possibility of the top wall 64 collapsing downwards into the sidewall 62. The cover 60 with the ridge portion 80 also provides a uniform performance for varying pipe sizes, which can reduce tooling variations needed during manufacture. Further, the cover 60 with the base 4 ensures that mating faces are always the same frictional resistance giving repeatability of lift regardless of the age and condition of the vent pipe. Accordingly, the cover 60 with the ridge portion 80 allows there to be the sloping portions 82, 84 equally shaped and sized that that allows the pressure within the vent pipe to have an equal bearing on both sloping portions 82, 84 ensuring that the lifting of the pipe cap with the cover 60 has greater uniformity as compared to known designs.

It will be appreciated that the above-disclosed embodiments and other features and functions, or alternatives or varieties thereof, may be desirably combined into many other different systems or applications. Further, any term of degree used herein, such as “substantially” and “approximately”, means a reasonable amount of deviation of the modified word is contemplated such that the end result is not significantly changed. Also that various presently unforeseen or unanticipated alternatives, modifications, variations or improvements therein may be subsequently made by those skilled in the art which are also intended to be encompassed by the present disclosure.

1. A cap for covering an open end of a vent pipe including:
a base including a sealing surface, the base being configured to connect to the open end of the pipe;
a cover configured to seal the open end of the pipe and to seal to the sealing surface so as to allow a build-up of pressure within the pipe, and to be blown off the sealing surface when the pressure exceeds a predetermined threshold value, the cover having a different visual appearance than the sealing surface; and
an anchor assembly connecting the cover to the base before, during, and after the pressure event, and allowing the cover to be blown off of the sealing surface during the pressure event.

2. The cap of claim 1, wherein the sealing surface is configured to provide a visual indication of a status of operation of the cap.

3. The cap of claim 1, wherein the cover is arranged over the base, a sidewall of the cover is arranged around and in contact with the sealing surface of the base to form a seal therewith.

4. The cap of claim 3, wherein the cover includes a closed end for closing off the open end of the pipe, a top wall of the closed end is sloped away from the open end of the pipe.

5. The cap of claim 4, wherein top wall includes a ridge portion and sloping portions, the sloping portions extend obliquely downward from the ridge portion to an upper end of the sidewall.

6. The cap of claim 5, wherein the sidewall is cylindrical shaped, and the ridge portion is centrally located on the top wall so as to extend diametrically relative to a central axis defined by the sidewall.

7. The cap of claim 5, wherein each sloping portion includes a respective arcuate shaped edge portion, and in a top view of the cover each sloping portion is approximately semicircular shaped relative to the cylindrical shaped sidewall.

8. The cap of claim 5, wherein the top wall of the cover with the ridge portion and sloping portions is configured to allow pressure within the vent pipe to have an equal bearing on both sloping portions.

9. The cap of claim 1, wherein the anchor assembly includes a loop attached around the base and a strap interconnecting the cover and the loop.

10. The cap of claim 9, wherein the anchor assembly includes tabs spaced around the circumference of the cover and loop and interconnecting the cover and the loop, the tabs configured to break during a pressure event so as to allow the cover to be blown off of the base.

11. The cap of claim 1, wherein the anchor assembly includes at least one lanyard connected to and extending down from the cover, the at least one lanyard secured to the base.

12. The cap of claim 1, wherein the anchor assembly includes a sensor configured to detect movement of the cover relative to the base during a pressure event.

13. A method of monitoring for the occurrence of a pressure event inside a vent pipe, including:
arranging a base, including a sealing surface, to an open end of the pipe;
sealing a cover to the sealing surface, the cover sealing the open end of the pipe so as to allow a build-up of pressure within the pipe, the cover being configured to be blown off the sealing surface when the pressure exceeds a predetermined threshold value, the cover having a different visual appearance than the sealing surface; and
connecting the cover to the base with an anchor assembly, the anchor assembly being configured to connect the cover to the base before, during, and after the pressure event, and allowing the cover to be blown off of the sealing surface during the pressure event.

14. The cap of claim 13, wherein the cover includes a sidewall and a closed end having a top wall for closing off the open end of the pipe, and the method includes providing the top wall with a ridge portion and sloping portions, and extending the sloped portions obliquely downward from the ridge portion to an upper end of the sidewall.

15. The method of claim 14, including configuring the ridge portion and the sloping portions to allow pressure within the vent pipe to have an equal bearing on both sloping portions.

16. The method of claim 13, wherein the anchor assembly includes a loop and a strap, and the method includes attaching the loop around the base and interconnecting the cover and the loop with the strap.

17. The method of claim 13, wherein the anchor assembly includes at least one lanyard connected to and extending down from the cover, and the method includes securing the at least one lanyard to the base.
